(19) United States
(12) Patent Application Publication
(10) Pub. No.: US 2026/0078704 A1
(43) Pub. Date: Mar. 19, 2026

(54) ACOUSTIC SANDWICH PANEL WITH IMPROVED MOUNTING

(71) Applicant: SAFRAN NACELLES, Gonfreville-L'Orcher (FR)

(72) Inventor: Romain BILLAULT-CHAUMARTIN, Moissy-Cramayel (FR)

(73) Assignee: SAFRAN NACELLES, Gonfreville-L'Orcher (FR)

(21) Appl. No.: 19/329,923

(22) Filed: Sep. 16, 2025

(30) Foreign Application Priority Data
Sep. 18, 2024 (FR) FR2409930

(51) Int. Cl. F02C 7/24; F02K 7/10

(52) U.S. Cl. CPC F02C 7/24; F02K 7/10; F05D 2260/96

(57) ABSTRACT

An acoustic panel including a first skin and a second skin extending on either side of an acoustic core, the acoustic panel also having a flank connecting the first skin and the second skin, one of the first skin and the second skin including a light opening into a cavity made in the acoustic core, a first attachment component extending into the cavity in the immediate vicinity of an inner face of the flank.

### TECHNICAL FIELD OF THE INVENTION

The present invention relates to the field of acoustic insulation sandwich panels, and more specifically to the implementation of such panels in turbojet engine nacelles.

It relates more specifically to the junction of an air inlet on the nacelle casing, also referred to as fan casing in the case of a twin-flow turbine engine.

The invention applies to all turbine engine designs, for example, turbofans driven directly by a low-pressure spool, driven indirectly by a reduction gear, single-spool, twin-spool, single-flow and twin-flow turbojets.

### PRIOR ART

In a turbine engine, here a turbojet of central axis AX, air is admitted, in a longitudinal direction parallel to the axis AX, into an inlet duct to pass through a fan comprising a series of rotary blades before splitting into a central primary flow which flows in a so-called flow path of a primary airflow and a secondary flow surrounding the primary flow.

The primary flow is compressed by compressor stages before reaching a combustion chamber, after which it expands by passing through turbines, before being discharged by generating a thrust. The secondary flow is in turn propelled directly by the fan to generate the main thrust.

The turbojet also includes a nacelle which supports the turbojet elements and ensures the connection of the turbojet to the aircraft. The nacelle includes a fan casing at the upstream end of which an air inlet—also referred to as air inlet lip—is attached. The air inlet conventionally includes an annular structure and a substantially transverse rear partition which connects a radially inner shroud and a radially outer shroud of the annular structure. Aircraft noise emission reduction requirements have led to the installation of acoustically treated panels to define the radially inner shroud (that which is in contact with the air inlet flow) of the air inlet.

These panels, of the sandwich type, are generally composite structures that consist of two rigid outer skin layers (most often made of aluminum or composite materials) and of a light central core, often made of materials such as foam or honeycomb. The acoustic treatments applied to these panels aim to improve the noise attenuation performance thereof, which is crucial for passenger comfort and compliance with environmental regulations.

There are three main types of acoustically treated sandwich panels: SDOF (Single Degree of Freedom) panels, 2DOF (Double Degree of Freedom) panels, and multilayer panels.

SDOF (Single Degree of Freedom) sandwich panels are designed with a single acoustic resonance mechanism. These panels consist of two layers of skin and a homogeneous core. The acoustic performance thereof is mainly determined by core density and skin thickness. These panels are easy to manufacture and are often used in applications where moderate noise attenuation is sufficient.

2DOF (Double Degree of Freedom) sandwich panels incorporate two acoustic resonance mechanisms, thus providing better attenuation performance over a wider frequency range. This type of panel usually has two different core layers separated by an intermediate layer, which makes it possible to effectively handle low and high frequencies. 2DOF panels are more complex to manufacture but offer significant noise reduction benefits.

Multilayer sandwich panels include multiple layers of cores and skins, making very fine acoustic control possible. These structures can be customized to meet specific noise attenuation needs at various frequencies. The manufacturing complexity thereof is high, but they offer the best acoustic performance among sandwich panel types.

The skins of sandwich panels are generally manufactured from composite or metal materials. Composite materials often consist of resin-impregnated carbon or glass fibers, while metal skins are typically made of aluminum or titanium. The manufacturing of skins requires forming processes such as vacuum molding, autoclaving or thermoforming.

The cores, in turn, can be manufactured from materials such as polymer foam, honeycomb structures or honeycomb materials. Polymer foam is manufactured by molding or extrusion, while honeycomb structures are obtained by rolling and expanding. The honeycomb materials can be produced by extrusion or injection.

The assembly of sandwich panel components is typically carried out by gluing, using structural adhesives capable of maintaining the mechanical and acoustic integrity of the structure. The assembly processes may include hot pressing, vacuum bonding, and the use of mechanical fasteners to strengthen the adhesion. Some panels may also incorporate a metal honeycomb core brazed onto metal skins.

Conventionally, the connection of sandwich panels to one another is carried out by specific bonding or welding techniques, ensuring structural and acoustic continuity. The adhesives used must offer excellent resistance to fatigue and aerospace service environments.

For the connections between sandwich panels and non-sandwich elements (such as metal or monolithic composite structures), bonding, bolting or riveting techniques can be used. For the latter two techniques, a flange-type assembly is produced which includes a first flange and a second flange of which the respective connecting faces are in contact. A bolt or a rivet is engaged through the aligned holes of the two flanges to then exert a joining force on bearing faces of each flange opposite to the connecting faces.

For revolving parts, forming these flanges requires bending the outer skin radially so that it meets the inner skin radially, and, at a distance from this joint, bending the inner skin radially ninety degrees to create the flange. This creates an area devoid of an acoustic core and whose axial length corresponds at least to the length of the screw, rivet or clamping or riveting tool. This area reduces the surface area of the sandwich panel which is acoustically treated. Finally, the shaping of the flange and the joining of the skins implement complex and costly panel manufacturing techniques.

### DISCLOSURE OF THE INVENTION

The object of the present invention is to improve the acoustic insulation of a composite panel structure assembled to an element of a different nature and to reduce the costs of such an assembly.

For this purpose, an acoustic panel is provided including a first skin and a second skin extending on either side of an acoustic core, the acoustic panel also having a flank connecting the first skin and the second skin. According to the invention, one of the first skin and the second skin includes an opening leading into a cavity made in the acoustic core, a first fastening component extending into the cavity in the immediate vicinity of an inner face of the flank.

According to other particular, non-exclusive and optional embodiments of the invention:
the acoustic panel is in the shape of a revolving part sector;
the opening is a portion of a ring sector and the first fastening component is a counter-flange sector;
the counter-flange sector includes at least one threaded portion;
the opening is circular and/or the first fastening component is a barrel nut;
the flank extends orthogonally to the first skin and/or to the second skin;
the fastening component includes a first shroud that extends in the opening to come in continuity of the first skin.

The invention also relates to an assembly of an acoustic panel as defined above on a flange of an element, wherein the flank includes an outer face opposite the inner face, the outer face being in contact with a connecting face of the flange, a second fastening component extending through the flange and the flank to cooperate with the first fastening component and to apply a bearing force of the flange on the flank.

Advantageously, the flank includes an outer face opposite the inner face, the outer face being in contact with a connecting face of the flange, a second fastening component extending through the flange and the flank to cooperate with the first fastening component and to apply a bearing force of the flange on the flank, and wherein the element includes a second shroud that extends in the opening to come in continuity of the first skin.

The invention also relates to a propulsion assembly including a turbojet engine and a nacelle including an assembly of an acoustic panel as defined above.

Other features and advantages of the invention will become apparent upon reading the following description of particular non-limiting embodiments of the invention.

### BRIEF DESCRIPTION OF THE FIGURES

The invention will be better understood upon reading the following description, given as a non-limiting example, and made with reference to the figures which show:

FIG. 1 is a schematic sectional representation of a turbojet equipped with an acoustic panel according to the invention;

FIG. 2 is a schematic partial detailed sectional representation of an air inlet equipped with an acoustic panel according to a first embodiment of the invention;

FIG. 3 is a schematic perspective representation of an acoustic panel according to a first embodiment of the invention;

FIG. 4 is a schematic partial detailed sectional representation of an assembly including the acoustic panel of FIG. 2 devoid of fastening components;

FIG. 5 is a schematic partial detailed sectional representation of an assembly including the acoustic panel of FIG. 2 provided with fastening components;

FIG. 6 is a schematic partial detailed sectional representation of an assembly including an acoustic panel according to a second embodiment of the invention and which is devoid of fastening components;

FIG. 7 is a schematic partial detailed sectional representation of an assembly including an acoustic panel according to the second embodiment of the invention provided with the fastening components;

FIG. 8 is a schematic partial detailed sectional representation of an assembly including an acoustic panel according to a third embodiment of the invention and which is devoid of fastening components;

FIG. 9 is a schematic partial detailed sectional representation of an assembly including an acoustic panel according to the third embodiment of the invention provided with fastening components;

FIG. 10 is a schematic partial detailed sectional representation of an assembly including an acoustic panel according to a fourth embodiment of the invention and which is devoid of fastening components;

FIG. 11 is a schematic partial detailed sectional representation of an assembly including an acoustic panel according to the fourth embodiment of the invention provided with fastening components;

FIG. 12 is a schematic partial detailed sectional representation of an assembly including an acoustic panel according to a fifth embodiment of the invention provided with fastening components;

FIG. 13 is a schematic partial detailed sectional representation of an assembly including an acoustic panel according to a sixth embodiment of the invention provided with fastening components;

FIG. 14 is a schematic partial detailed sectional representation of an assembly including an acoustic panel according to a seventh embodiment of the invention provided with fastening components.

### DESCRIPTION OF THE EMBODIMENTS

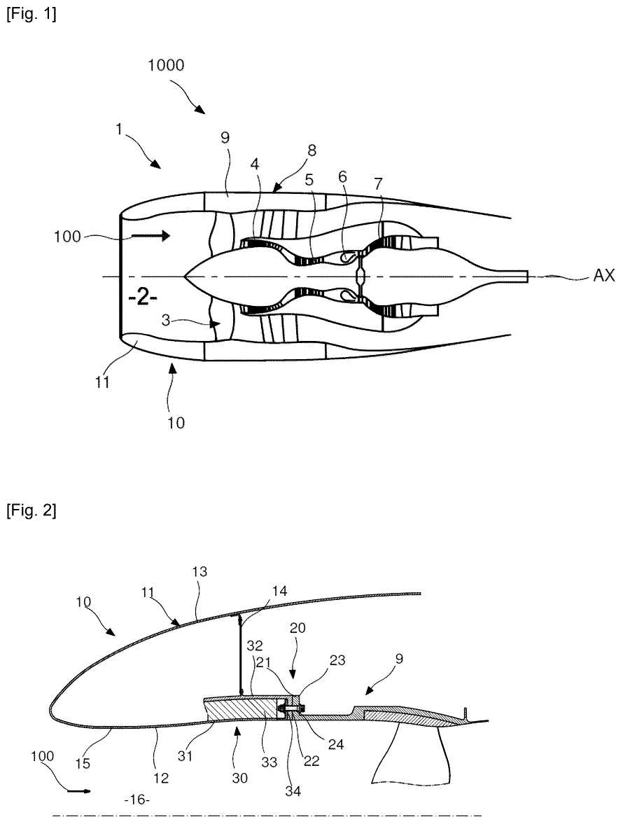

With reference to FIGS. 1 and 2, a propulsion assembly 1000 includes a turbine engine, here a turbojet generally referenced 1, wherein an airflow 100 is admitted, in a longitudinal direction parallel with the axis AX of rotation of the turbine engine 1, into an inlet duct 2 to pass through a fan having a series of rotary blades 3.

Part of the airflow 100 is compressed by compressor stages 4 and 5 before reaching a combustion chamber 6, after which it expands by passing through turbines 7, before being discharged by generating a thrust. The remainder of the airflow 100 is in turn propelled directly by the fan to generate the main thrust.

In the present text, the terms “inner” or “outer” are used with reference to the position or the orientation relative to the axis of rotation of the turbines 7.

In the present text, the terms “upstream” and “downstream” are used with reference to the position or the orientation of an element in the flow direction of the airflow 100 in the turbojet 1.

As a preliminary measure, an axial direction, a radial direction which is orthogonal to the axial direction and a circumferential/tangential direction which is orthogonal to the axial and radial directions, is defined.

The turbojet 1 also includes a nacelle 8 which supports the elements of the turbojet 1 and ensures the connection thereof to an aircraft not shown. The nacelle 8 includes a fan casing 9 wherein the upstream end particularly includes an upstream casing flange 20 whereon an air inlet 10 is attached. The upstream flange 20 includes a web 21 which extends radially from the casing 9 outward. The web 21 comprises an upstream connecting face 22 and a downstream bearing face 23. A plurality of holes 24 extend through the web 21 to connect the connecting face 22 and the bearing face 23.

The air inlet 10 includes an annular structure 11 of longitudinal axis merged with the axis AX and includes an inner shroud 12 and an outer shroud 13.

As seen in FIG. 2, the inner shroud 12 delimits a radially outer wall 15 of a flow path 16 of the airflow 100. The inner shroud 12 is, here, made of a sandwich-type acoustic panel 30.

In the following description, the parts being revolving parts or sectors of such parts, only a cross-section will be described, it being understood that such a cross-section is conventionally repeated according to a rotation of longitudinal axis AX.

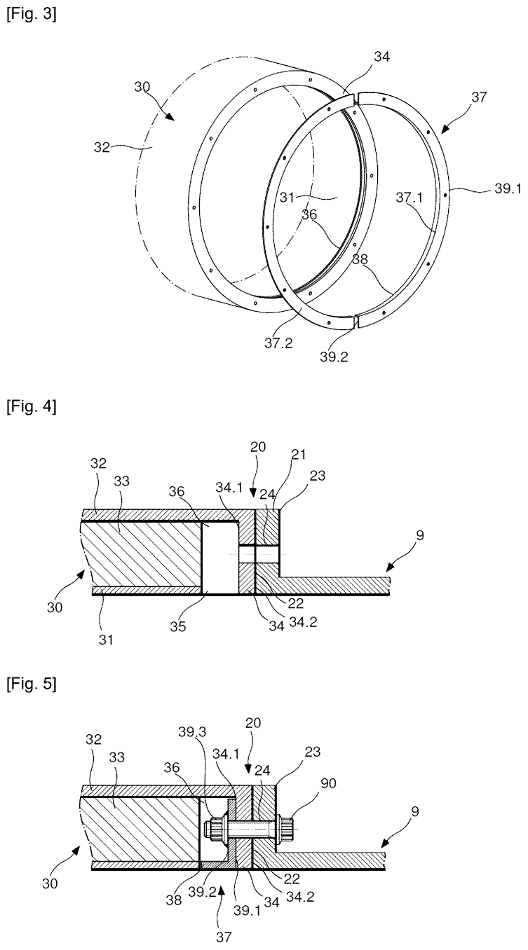

With reference to FIGS. 2 to 5, the acoustic panel 30 is here in the shape of a straight cylinder and includes a first inner skin 31 and a second outer skin 32 extending on either side of an acoustic core 33. The panel 30 also has a downstream flank 34 connecting the inner skin 31 and the outer skin 32. The inner skin 31 includes an opening 35—here an annular opening-made in the inner skin 31 and which leads to a cavity 36—here an annular groove—made in the acoustic core 33. A counter-flange 37 made in the form of two half counter-flanges 37.1 and 37.2 each describing a counter-flange sector of about one hundred and eighty degrees extends into the cavity 36 in the immediate vicinity of an inner face 34.1 of the flank 34. As can be seen in FIGS. 3 and 5, the counter-flange 37 includes a first shroud 38 which extends into the opening 35 to come in continuity with the inner skin 31, in an axial direction. The counter-flange 37 includes a connecting face 39.1 facing the inner face 34.1 of the flank 34 and a bearing face 39.2 whereon nuts 39.3 are welded.

The panel 30 can be manufactured according to the following steps:
forming the inner skin 31;
forming the outer skin 32;
forming the acoustic core 33;
forming the flank 34;
assembling and securing the skins 31 and 32 with the flank 34 and the core according to procedures known to the person skilled in the art;
machining the opening 35.

Alternatively, creating the opening 35 can take place prior to forming the inner skin 31.

The assembly of the panel 30, equipped with the counter-flange 37, on the flange 20 of the casing 9 is carried out by placing in contact an outer face 34.2 of the flank 34, which is opposite the inner face 34.1, with the connecting face 22 of the flange 20. Counter-drilling of the flank 34 is then carried out using the flange 20 as a template. Alternatively, the flank 34 was previously pierced during the manufacture of the panel 30, before or after the assembly of the flank 34 on the skins 31 and 32. Screws 90 are then engaged in the holes 24 to extend through the flange 20 and the flank 34. The screws 90 then cooperate with the nuts 39.3 and screwing the screws 90 into the nuts 39.3 makes it possible to apply a bearing force on the face 39.2 of the counter-flange 37 and on the face 23 of the flange 20 to assemble the flange 20 on the flank 34, and thus connect the air inlet 10 to the casing 9.

A simple, reliable flange assembly is then obtained, which is cost-effective to implement and makes it possible to optimize the acoustic protection surface. Finally, using a reduced number of parts, the invention makes it possible to guarantee continuity of the inner shroud of the flow path 16.

Elements that are identical or analogous to those described above have a numerical reference that is identical thereto in the following description of a second, third and fourth embodiment of the invention.

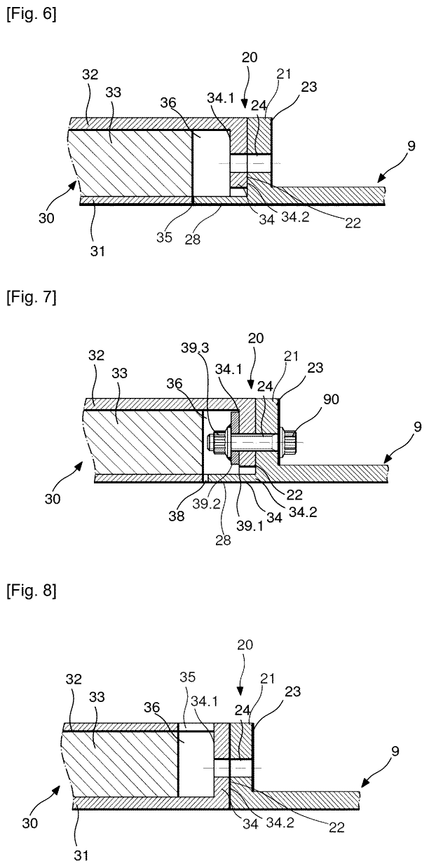

According to a second embodiment of the invention shown in FIGS. 6 and 7, the opening 35 extends up to the outer face 34.2 and the casing 9 includes a second shroud 28 which protrudes axially from the web 21 to extend into the opening 35 and comes in continuity of the inner skin 31. The assembly of the panel 30 on the flange 20 is carried out according to identical procedures to those described above.

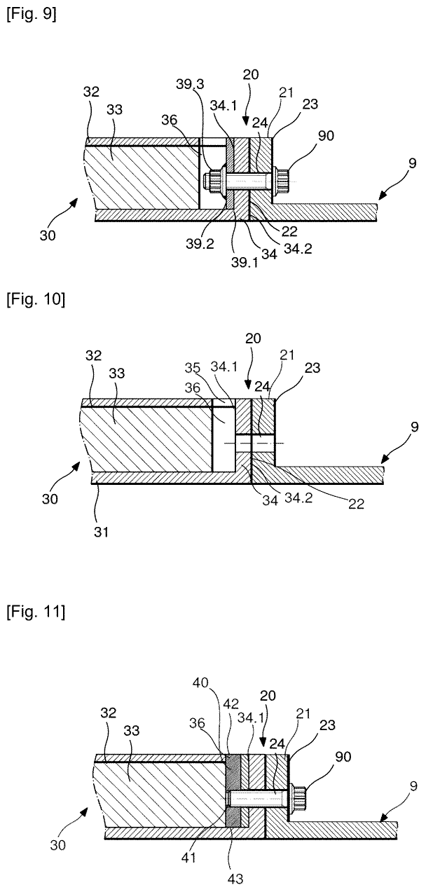

According to a third embodiment of the invention shown in FIGS. 8 and 9, the opening 35 is made in the outer skin 32 and is in the shape of an annular opening. The opening 35 leads to the cavity 36—here an annular groove—made in the acoustic core 33 to accommodate the counter-flange 37. The assembly on the flange 20 is carried out according to identical procedures to those described above. The counter-flange 37 is, here, devoid of a shroud because the creation of the opening 35 in the outer skin makes it possible to preserve the continuity of the inner skin 31.

According to a fourth embodiment of the invention shown in FIGS. 10 and 11, the opening 35 is produced in the outer skin 32 by a core drilling extending in a substantially radial direction. The opening 35 is here circular and the cavity 36 is in the shape of a straight cylinder of radial axis. A barrel nut 40 extends in the cavity 36 so that the threaded portion 41 thereof extends axially. As can be seen in FIGS. 10 and 11, the radially outer face 42 of the nut 40 extends into the opening 35 to come in continuity of the outer skin 32. The radially inner face 43 of the nut 40 comes into contact with a radially outer face 31.1 of the skin 31.

A simple, reliable flange assembly is then obtained, which is cost-effective to implement and makes it possible to optimize the acoustic protection surface. Indeed, core drilling implements common and inexpensive tools. The inner skin 31 is preserved and the use of a plurality of barrel nuts 40 further optimizes the acoustic panel surface 30 which achieves effective acoustic protection.

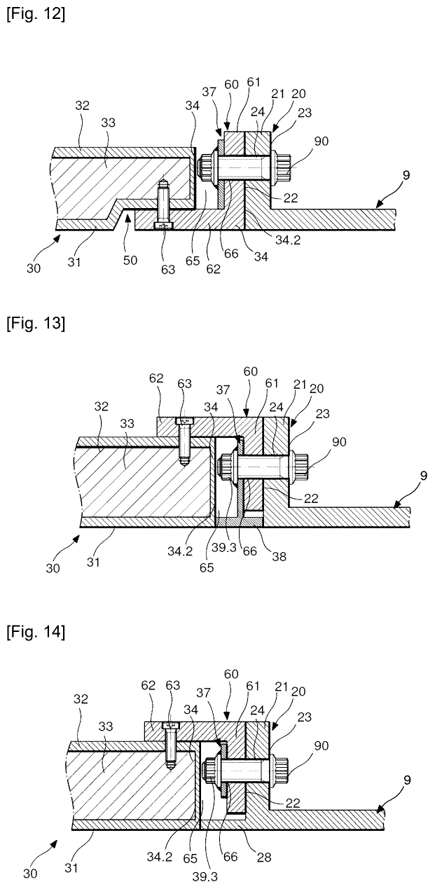

According to a fifth embodiment shown in FIG. 12, the inner skin 31 has, at the connection thereof with the flank 34, an annular recess 50 made via a radially outer offset of the inner skin 31. An additional flange 60 has a substantially L-shaped section which includes a core 61 extending substantially radially and protruding axially from which a wing 62 extends upstream of the core 61. The wing 62 extends into the recess 50 and is fastened to the panel 30 by screwing using radial screws 63. The flank 34 extends at a non-zero distance from the upstream bearing face 64 of the core 61 to define an annular housing 65. The annular housing 65 is opened at the radially outer edge thereof to accommodate the counter-flange 37. The core 61 includes a plurality of holes 66 arranged to face the holes 24 of the flange 20.

The assembly of the panel 30 equipped with the counter-flange 37, on the flange 20 of the casing 9 is carried out by placing in contact a downstream connecting face 67 of the core 61 which is opposite the upstream bearing face 64 with the connecting face 22 of the flange 20. The holes 66 of the additional flange 60 then face the holes 24 of the flange 20. Screws 90 are then engaged in the holes 24 to extend through the flange 20 and the holes 66 of the additional flange 60. The screws 90 then cooperate with the nuts 39.3 and screwing the screws 90 into the nuts 39.3 makes it possible to apply a bearing force on the face 39.2 of the counter-flange 37 and on the face 23 of the flange 20 to assemble the flange 20 on the additional flange 60 of the panel 30.

According to a sixth embodiment shown in FIG. 13, the wing 62 of the additional flange 60 extends facing the outer skin 32 and is fastened to the panel 30 by screwing using radial screws 63 into the outer skin 32. The flank 34 extends at a non-zero distance from the upstream bearing face 64 of the core 61 to define an annular housing 65. The annular housing 65 is, according to this sixth embodiment, open at the radially inner edge thereof to accommodate the counter-flange 37.

The counter-flange 37 includes a shroud 38 which extends continuously from the inner skin 31, in an axial direction, to connect the face 34.2 of the flank 34 and the face 22 of the flange 20 and ensure continuity of the shroud of the flow path 16. The assembly of the panel 30 on the flange 20 is carried out according to identical procedures to those described above.

According to a seventh embodiment shown in FIG. 14, the wing 62 of the additional flange 60 extends facing the outer skin 32 and is fastened to the panel 30 by screwing using radial screws 63 into the outer skin 32. The flank 34 extends at a non-zero distance from the upstream bearing face 64 of the core 61 to define an annular housing 65. The annular housing 65 is, according to this sixth embodiment, open at the radially inner edge thereof to accommodate the counter-flange 37.

The casing 9 includes a shroud 28 which protrudes axially from the web 21 to extend up to the face 34.2 of the flank 34 and comes in continuity of the inner skin 31.

Of course, the invention is not limited to the embodiments described, but encompasses any alternative embodiment that falls within the scope of the invention as defined by the claims.

In particular:
although here the acoustic panel is in the form of a straight cylinder and thus describes a cylinder sector of three hundred and sixty degrees, the invention also applies to other configurations of the acoustic panel such as for example an acoustic panel in the form of a cylinder sector of ninety degrees, four sectors being then necessary to define the complete cylindrical envelope of the air inlet;
although here the opening is an annular opening and thus describes a three hundred and sixty-degree ring sector, the invention also applies to other configurations of the opening such as for example an opening shaped as an eighty-degree ring sector, four sectors being then implemented to achieve the fastening of the air inlet;
although here the counter-flange is made in the form of two half counter-flanges each describing a counter-flange sector of one hundred and eighty degrees, the invention also applies to other configurations of the first fastening component such as for example a counter-flange made in the form of four counter-flange sectors each describing a counter-flange sector of about eighty degrees, four sectors being then implemented to make the counter-flange;
although here the opening is of circular shape and made by core drilling, the invention also applies to other opening forms such as for example polygonal or non-circular openings in order to be able to block a rotation of the barrel on itself about a radial axis;
although here the flange receives welded nuts, the invention also applies to other procedures for equipping a counter-flange with threaded portions, such as for example making threaded bores in the counter-flange body or attaching cage nuts.
although here the panel includes a counter-flange provided with threaded holes to make a flange connection using screw/nut-type screwed elements, the invention applies equally to other types of first fastening component and second fastening component such as for example a riveted assembly wherein the counter-flange is devoid of threaded holes;
although here the assembly of the panel on the casing flange is made using screws, the invention also applies to other types of second fastening components such as for example rivets.
although here the panel according to the invention has been described in application to an air inlet, the invention also applies to other types of structures such as for example a downstream portion of the flow path;
although here the inner shroud defines the inner wall of an air flow path, the invention also applies to an inner shroud which would partially define such a flow path, such as for example an inner shroud connected to another element which would also contribute to the definition of the flow path;
although here the casing and air inlet flanges are described as circular revolving elements, the invention also applies to flanges composed of a plurality of ring sectors;
although here the assembly of the air inlet on the casing is carried out using two flat flanges bolted or riveted together, the invention also applies to other flange-type assemblies such as for example screwed flanges or conical edge flanges:
although here the invention has been described applied to a propulsion assembly including a twin-flow and twin-spool turbojet, the invention also applies to propulsion assemblies including other types of turbine engines such as for example a propulsion assembly including a twin-flow and single-spool turbojet.

1. An acoustic panel comprising a first skin and a second skin extending on either side of an acoustic core, the acoustic panel also having a flank connecting the first skin and the second skin, one of the first skin and the second skin including an opening leading to a cavity made in the acoustic core, the flank delimiting the cavity jointly with the acoustic core, a first fastening component extending into the cavity in the immediate vicinity of an inner face of the flank.

2. The acoustic panel according to claim 1, wherein the acoustic panel is shaped as a sector of a part of revolution.

3. The acoustic panel according to claim 2, wherein the opening is a portion of a ring sector and the first fastening component is a counter-flange sector.

4. The acoustic panel according to claim 3, wherein the counter-flange sector includes at least one threaded portion.

5. The acoustic panel according to claim 1, wherein the opening is circular and/or the first fastening component is a barrel nut.

6. The acoustic panel according to claim 1, wherein the flank extends orthogonally to the first skin and/or to the second skin.

7. The acoustic panel according to claim 1, wherein the fastening component comprises a first shroud which extends into the opening to come in continuity of the first skin.

8. An assembly of an acoustic panel according to claim 1 on a flange of an element, wherein the flank comprises an outer face opposite the inner face the outer face being in contact with a connecting face of the flange a second fastening component extending through the flange and the flank to cooperate with the first fastening component and to apply a bearing force to the flange on the flank.

9. The assembly of an acoustic panel according to claim 1 on a flange of an element, wherein the flank comprises an outer face opposite the inner face the outer face being in contact with a connecting face of the flange, a second fastening component extending through the flange and the flank to cooperate with the first fastening component and to apply a bearing force of the flange on the flank, and wherein the element includes a second shroud that extends into the opening to come in continuity of the first skin.

10. A propulsion unit comprising a turbojet and a nacelle including an assembly of an acoustic panel according to claim 8.
